(19) United States
(12) Patent Application Publication
(10) Pub. No.: US 2004/0191381 A1
(43) Pub. Date: Sep. 30, 2004

(54) Method and a system for converting liquid products into free-flowing powders with spray drying

(76) Inventor: Jens Getler, Bronshoj (DK)

Correspondence Address: BIRCH STEWART KOLASCH & BIRCH, PO BOX 747, FALLS CHURCH, VA, 22040-0747, US

(21) Appl. No.: 10/476,010

(22) PCT Filed: Apr. 25, 2002
(86) PCT No.: PCT/DK02/00270

(30) Foreign Application Priority Data
Apr. 26, 2001 (DK) PA 2001 00658

(51) Int. Cl. A22C 5/00

(52) U.S. Cl. 426/520

(57) ABSTRACT

The present invention relates to a method and a system for converting liquid products from the cheese making or casein producing industry into substantially free-flowing powdery products, by heating the liquid product to a temperature above the crystallisation temperature of any component in the liquid product in a heat exchanger, flash separating volatile components from said heated liquid product to obtain a paste concentrate, and spray drying said paste to obtain a free flowing powder. By the present method it has been found that it is possible to substantially avoid formation of crystals before atomization and thereby on the one hand render atomization possible. Secondly it has been found that the crystallisation process according to the present method takes place in the spray dryer during the drying process and probably during the conditioning /cooling in the fluid bed. This means that there is no need for crystallisation tanks and for heavy-duty mixers.

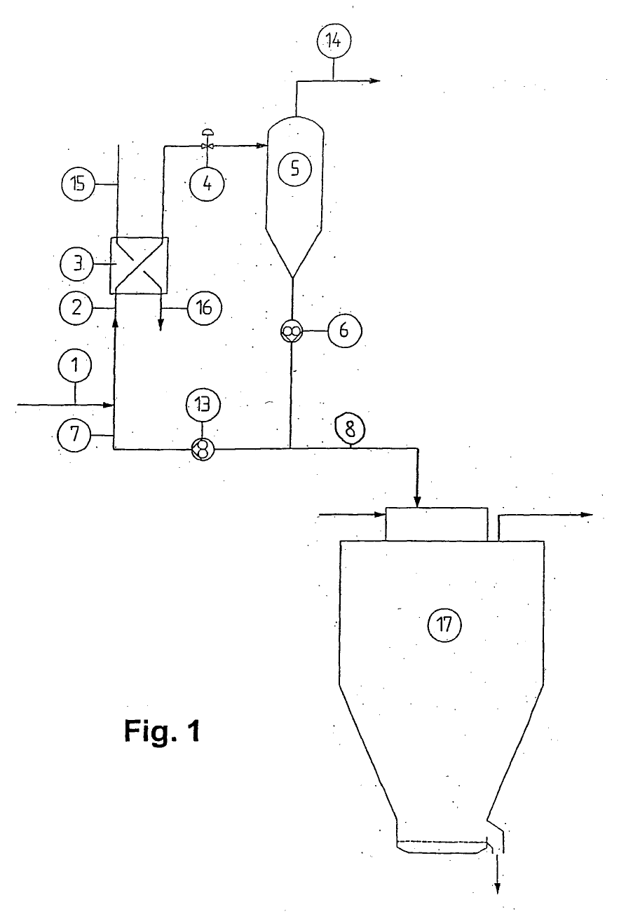

### FIELD OF THE INVENTION

The present invention relates to a method and a system for converting liquid products from the cheese making or casein producing industry into substantially free-flowing powdery products.

1. Background of the Invention

The traditional cheese making and casein manufacturing industry produce a series of liquid products and by-products, in the present context termed whey: acid whey, sweet whey, salt whey, permeates from the production of whey protein or milk protein concentrates. Other liquid products are lactose solution, mother liquor from lactose crystallisation, demineralised whey and the like.

Depending on origin the whey contains 5.5-6.5% total solids, wherein 0.7-0.9% protein, 0.05% fat, 4.2-4.6% lactose and 0.5-0.8% ash.

Usually, after a number of pre-treatments, the aqueous whey is a solution in which the lactose is in an equilibrium of 60% beta- and 40% alpha molecular form. This mixture is very hygroscopic and unsuitable for drying for creating a free flowing powder. However, the whey solution may be dried into a suitable powder if a major part of the lactose during the processing is crystallised into the alpha monohydrate form.

2. Description of prior art

In the prior art several processes are known for converting liquid products, such as whey as defined above, into substantially free-flowing, non-caking powdery products. Major processes are mentioned in PCT application WO 00/72692 (APV Nordic, Anhydro) to which reference is made. In processes commonly carried out by industry, the whey solution is concentrated up till 50 or 66% total solids and cooled slowly batchwise in large tanks for crystallisation of lactose. After crystallisation, the concentrate is spray dried to its final moisture content and cooled in a fluid bed. (Masters, Spray Drying Handbook, 4 ed. 1985, p.596).

In WO 00172692 mentioned above, a process is described in which the liquid is concentrated to at least 65% TS or at least 70% by flash evaporation while keeping the temperature above the crystallisation temperature of the liquid product. Crystallisation is then carried out in one or more steps by cooling and the product is finally dried (in a Spin Flash® dryer).

It has been found, however, that the crystallisation process makes the whey paste from the evaporator highly viscous and difficult to handle and disintegrate in the Spin Flash® dryer in large scale production, and the process only allows for relatively heavy duty mixing and feeding equipment.

### SUMMARY OF THE INVENTION

The present invention relates to a method for converting a liquid product into a substantially free-flowing powder, said method comprising the steps of

heating the liquid product to a temperature above the crystallisation temperature of any component in the liquid product in a heat exchanger,

flash separating volatile components from said heated liquid product to obtain a paste concentrate, and

spray drying said paste to obtain a free flowing powder.

In a preferred embodiment, a free-flowing, non-caking powder is obtained. The powder flowability may be measured according to Cheremisinoff (see below) whereby a free-flowing powder is having an angle of repose of 30 or less. The caking properties are estimated by examining the crust formed on a spoonful of powder, subjected to 60% relative humidity at 20° C. for 24 hours. A non-caking powder does not form any crust under these conditions. A non-caking powder is more stable than caking powders.

When the concentration process is carried out according to the invention a powder having very good properties in relation to flowability and preferably also cakability is obtained.

The term a powdery product means a product normally considered as powder, i.e. having a particle size corresponding to powder, such as preferably above 0.1 μm and preferably below 2 mm. The particle size is measured as the approximate diameter of the particle.

By the present invention it has been possible to concentrate the liquid product to a very high concentration of solids, avoiding crystallisation of any component in the liquid product.

Accordingly, the present invention further relates to a system for concentrating a liquid product, having a unit comprising means (2) for feeding a heat exchanger, a heat exchanger (3) and a separator vessel (5).

Further, the invention relates to a system for converting whey into a powdery product comprising means for concentrating a liquid product to obtain a paste concentrate as defined above and means for spray drying said concentrate to obtain free-flowing, which means are interconnected by a main conduit.

### DRAWING

The drawing is a schematic diagram of a system according to the invention for carrying out the method.

### DETAILED DESCRIPTION OF THE INVENTION

When concentrating liquid products as defined above, it is of importance to control crystallisation, especially of lactose. Lactose crystals inevitably form deposits on heat exchanger surfaces and prevent heat transfer. Therefore the temperature of the liquid must be maintained above the temperature where crystals form during the evaporation process. High temperatures on the other hand promote the undesired browning (Maillard) reaction and denaturation of proteins (Reyes, F. G. G. (1982) J. Food Sci., 47, 1376-7). The undesired reactions are minimised by a short residence time at elevated temperatures in the heater. Therefore, a plate heat exchanger, with a short contact time, is preferred. Boiling induces deposits in the exchanger; it is suppressed by a pressure control valve (4). After heating the product is subjected to a flash evaporation process, see e.g. Perry's Chemical Engineer Handbook, 6 Ed. (1984) pp. 11-35 and 11-40 and the PCT-application mentioned above. The concentration method is preferably applied to whey products, whereby it is desired to obtain as high a total solids (TS) concentration as possible. In a preferred embodiment, concentration of raw whey leads to at least 75% TS at 75° C. whereas concentration of permeate leads to at least 82% TS at a temperature of about 96° C.

If such liquids are cooled a few degrees, a very high number of small lactose crystals will form immediately, the liquid viscosity will increase very rapidly, and further handling is very difficult.

However, according to the method of the present invention, any cooling and formation of crystals is avoided while the product is pumped to the atomizer of a conventional spray dryer with integrated fluid bed, see e.g. Masters, K, Spray Drying Handbook, 5 Ed., (1991), p. 609. Cooling may for example be avoided by insulating the conduits leading from the flash separator to the spray dryer. Thus, by the present invention the temperature of the paste concentrate is preferably kept constant from departure from the flash separator to the spray dryer.

By the present method it has become possible to concentrate and dry liquid products, in particular liquid whey products, and obtain a substantially free-flowing powder by a process hitherto unknown to industry.

The formation of crystals upstream of the drying process is a characteristic feature of prior art processes for converting liquid whey products into free flowing, non-caking powders. By the present method it has been found that it is possible to substantially avoid formation of crystals before atomization and thereby on the one hand render atomization possible. Secondly it has been found that the crystallisation process according to the present method takes place in the spray dryer during the drying process and probably during the conditioning/cooling in the fluid bed. This means that there is no need for crystallisation tanks and for heavy-duty, mixers.

Without being bound by theory, it is believed that the very high shear rate in a centrifugal or nozzle atomizer and rapid cooling of droplets because of evaporation of water leads to a hitherto unpredictable fast and extensive conversion of liquid lactose into stable, non-hygroscopic crystals.

The paste concentrate is preferably transferred directly to the dryer. However, it has been found that the concentration process is further improved if it comprises recirculation of at least a part of the concentrate. The recycled concentrate is then mixed with the liquid product before being fed to the heat exchanger.

The recirculation is preferably carried out by continuous recirculation of a predetermined partial flow of the liquid concentrate to the heat exchanger. Preferably, at least 75% of the liquid concentrate is continuously recycled to be mixed with liquid product and then entered into the heat exchanger to be reheated and subjected to a further separating step. In an even more preferred embodiment at least 90% of the liquid concentrate is continuously recycled. This may be accomplished by using conduits having different diameters when transferring the liquid product and the liquid concentrate to the heat exchanger. In particular a ratio of the cross-section area of the liquid concentrate conduit to the cross-section area of the liquid product conduit is at least 10:1, such as at least 25:1, more preferred at least 30:1, yet more preferred at least 50:1.

The ratio of liquid concentrate to liquid product in the mixture feeding the heat exchanger is preferably at least 3:1, such as at least 10:1, more preferred at least 25:1, most preferred at least 50:1.

Furthermore, the high percentage of recycling also leads to a high content of solids in the mixture of recycled liquid concentrate and liquid product. The high content of solids reduces the water activity and increases the viscosity leading to a low migration velocity of molecules. Without being bound by theory, it is believed that due to a high solid content in the liquid product the lactose molecules are “masking” the protein molecules, inhibiting unfolding and denaturation of the protein.

Highly concentrated whey is very viscous. However, due to the visco-elastic and thixotropic nature of whey concentrate, the circulation rate has a great influence on the viscosity of the liquid concentrate. The circulation rate is controlled to any suitable rate with respect to the apparatus in use. The rate is preferably as high as possible reducing the viscosity of the liquid concentrate. As a measure of the preferred flow rates in the separating vessel and the conduit through positive displacement pump a preferred ratio between their diameters is indicated. The diameter of the flash separating vessel is preferably in the range of from 3 to 30 times the diameter of the conduit leading to the pump more preferably the ratio of the diameter of the separating vessel to the diameter of the conduit is in the range from 10:1 to 20:1.

Various pretreatment of the liquid product before entering the line leading to the heat exchanger may be carried out. Also, a pre-concentration step may be conducted. In particular with respect to whey, a pre-concentration may be conducted whereby the solid content is increased from the starting concentration of about 6% to about 58%. The pre-concentration may be carried out by any suitablemethod known to the skilled person.

The method has been described with respect to one concentration unit comprising one heat exchanger and one flash separator. However, the method may also be conducted in a system comprising two or more units. Thereby, the concentration of the liquid concentrate solids is increased stepwise. For example with respect to whey, the concentration of the liquid concentrate from the first unit may be 66%, and from the second unit 73% starting with 58% in the liquid product. For each unit recirculation of the liquid concentrate within the unit may take place as described above. The method is even more energy-efficient when it is carried out stepwise.

Furthermore, in one embodiment a secondary stream is fed to the stream of paste concentrate, such as described in WO 00/172692.

Turning to the FIGURE, a preferred system comprising a concentration unit for concentrating is shown. The liquid product is fed to the system via a conduit (1) to a recirculation conduit (2). The recirculation conduit (2) leads to a heat exchanger (3) wherein the liquid product is heated to a temperature above the crystallisation temperature of the liquid product. The heat exchanger (3) is preferably a plate heat exchanger. The heat exchanger (3) is heated by steam or hot water which is led to the heat exchanger (3) through a conduit (15) and out through a conduit (16). Boiling in the heat exchanger is suppressed by a control valve (4). The liquid product is transferred into a separator vessel (5). Flash separation is carried out in the vessel (5), whereby the vapour is removed via a conduit (14) and the liquid concentrate obtained is removed via a conduit (6). In the preferred embodiment, the liquid concentrate obtained in conduit (6) is divided into a main stream flowing in a conduit (8) and a recirculation stream flowing in a conduit (7). The stream in conduit (7) is mixed with liquid product from conduit (1) and recycled to the heat exchanger (3) through conduit (2).

Conduit (8) takes the concentrate directly into an air dryer (17). Conduit (8) is preferably coated with insulating material. The dryer is preferably a spray/fluid bed dryer.

### EXAMPLE

The feed material for the experiment was pre-treated rennet cheese whey with 6.00% total solids and permeate from the production of milk protein by ultrafiltration of sweet whey with 5.50% total solids.

In all Experiments whey or permeate was pre-concentrated in a multistage MVR falling film evaporator with 50 mm tubes of 18 m length as described by e.g. Knip-schildt in Modern Dairy Technology (Ed. Robinson) 1986, Vol 1, p. 147 ff.

The experiments were performed according to the invention in a system as the one illustrated in the drawings. The concentrate from the falling film evaporator (not shown in the drawings) was fed to the recirculation line of a suppressed boiling forced circulation plate evaporator. After heating the separation process took place in a flash separator (a Single effect Paraflash, manufactured by APV Separation Processes). The concentrate from the exit line was then led to the cooler and subsequently fed directly to a spray dryer.

Feed kg/h 3300 3000

TS in feed % 58 58

TS in concentrate from evaporator % 83 76

Drying air inlet temperature C 175 180

Drying air outlet temperature C 82 85

Residual moisture in powder % 2 2

Flowability (1) excellent good

Caking properties (1) “moderate” “moderate”

(1) Referece is made to the text above

1. A method for converting a liquid whey product into a substantially free-flowing non-caking powder, said method comprising the steps of
heating the liquid product to a temperature above the crystallisation temperature of any component in the liquid product in a heat exchanger,
flash separating volatile components from said heated liquid product to obtain a paste concentrate,
keeping the temperature of the paste concentrate constant from flash separation to spray drying, and
spray drying said paste concentrate allowing crystals to form during spray drying to obtain a free flowing powder.

2. The method according to claim 1, wherein the drying step is performed in a spray/fluid bed dryer.

3. The method according to claim 1, wherein the liquid product is selected from acid whey, sweet whey, salt or demineralised whey, lactose, mother liquor from the production of lactose and permeate from the production of protein from milk or whey.

4. The method according to claim 1, wherein the heat exchanger is a plate heat exchanger.

5. The method according to claim 1, wherein the liquid product comprises at least 50% of solid, preferably at least 60%, more preferably at least 70% of solid.

6. The method according to claim 1, wherein the product temperature during the flash separation is in the range of 65-98° C., more preferably in the range of 70-96° C.

7. The method according to claim 1, wherein at least 75% of the paste concentrate obtained is mixed with liquid product and recycled to the heat exchanger to be reheated and subjected to the flash separating step.

8. A system for concentrating a liquid product comprising means (2) for feeding a heat exchanger, a heat exchanger (3), a separator vessel (5) and a spray dryer (17), connected by suitable conduits.

9. The system according to claim 8, wherein the heat exchanger (3) is a plate heat exchanger.

10. The system according to claim 8, wherein the separator vessel (5) is a flash separator.

11. The system according to claim 8, further comprising a secondary conduit (7) extending in a closed loop connection from the separator vessel (5) to the heat exchanger (3).
